(19) United States
(12) Patent Application Publication
(10) Pub. No.: US 2016/0073465 A1
(43) Pub. Date: Mar. 10, 2016

(54) DRIVER CIRCUIT WITH ADAPTIVE PEAKING CONTROL

(71) Applicant: Avago Technologies General IP (Singapore) Pte. Ltd., Singapore (SG)

(72) Inventors: Qian Tao, Singapore (SG); Gek Yong Ng, Singapore (SG)

(21) Appl. No.: 14/477,569

(22) Filed: Sep. 4, 2014

(51) Int. Cl. H05B 33/08; H04B 10/27

(52) U.S. Cl. CPC H05B 33/0851; H05B 33/0815; H04B 10/27

(57) ABSTRACT

A communication system implementing one or more a Light Emitting Diodes (LEDs) and a driver circuit for the same is disclosed. A method of driving the one or more LEDs is also disclosed. The driver circuit is disclosed to include a first input branch and a second input branch. The first input branch provides a first driving current to the one or more LEDs and the second input branch selectively provides a second driving current to the one or more LEDs. The magnitude of the second driving current is adjustable in response to variations in at least one characteristic of the one or more LEDs.

### FIELD OF THE DISCLOSURE

The present disclosure is generally directed toward driver circuits and methods of operating the same.

### BACKGROUND

Typical optical communication systems that utilize a light source such as a Light Emitting Diode (LED), laser diode, or the like, usually include a driver to energize and control the light source, thereby controlling the signals produced by the light source. This driver will inject a current signal into the light source, which converts the current signal into light. A light detector, such as a photodiode or the like, then detects the light emitted by the light source. Upon receiving the light, the light detector converts the light signal back into electrical current (e.g., an output current signal). The output current signal is usually provided to an amplifier, such as a Trans-Impedance Amplifier (TIA), for signal amplification. In almost every optical communication system, the signal quality output by the amplifier is critical and parameters like amplitude, strength, and shape can be directly correlated to the type and quality of driver used on the input side.

The speed of the optical communication system is usually limited by the driver of the light source, specifically by a turn-on speed. The reason for this limitation is because most light sources, such as LEDs, have a large junction capacitance C_{D} and light will only be emitted after the light source is charged up to its turn-on threshold voltage V_{D}. Techniques like capacitor-charge peaking and current-pulse peaking have been developed to speed up the turn-on process by instantaneously injecting a large amount of charge Q_{D} to the light source to raise its voltage V_{D}.

Since energy is always preserved, the following equation can be derived:

Q_{D}=V_{D}*C_{D}+Qₑₓₜ

Here Qₑₓₜ corresponds to the excess charge left after the light source is fully turned-on, and this amount of charge will be transferred into light and will, therefore, be sensed by the light detector. The amount of charge Q_{D} is usually pre-determined and based on the design of the optical communication system. It can be observed that when Qₑₓₜ is excessively large, a peaking pulse can appear, which ultimately introduces noise or glitches into the optical communication system. Conversely, when Q_{D} is not large enough, the rise time for the light source will be sluggish, thereby resulting in Pulse Width Distortion (PWD). Unfortunately, the ideal operating conditions are not achievable, especially when process, voltage, and temperature (PVT) varies for the light source.

### BRIEF DESCRIPTION OF THE DRAWINGS

The present disclosure is described in conjunction with the appended figures, which are not necessarily drawn to scale:

FIG. 1 is a block diagram depicting an optical communication system in accordance with embodiments of the present disclosure;

FIG. 2 is a circuit depicting details of an optical communication system in accordance with embodiments of the present disclosure;

FIG. 3A depicts a first configuration of driver circuitry in accordance with embodiments of the present disclosure;

FIG. 3B depicts a timing diagram for the switches depicted in FIG. 3A;

FIG. 4 depicts a second configuration of driver circuitry in accordance with embodiments of the present disclosure;

FIG. 5A depicts a third configuration of driver circuitry in accordance with embodiments of the present disclosure;

FIG. 5B depicts a timing diagram for the switches depicted in FIG. 5A; and

FIG. 6 is a flow diagram depicting a method of driving an LED in accordance with embodiments of the present disclosure.

### DETAILED DESCRIPTION

It is with respect to the above-noted challenges that embodiments of the present disclosure were contemplated. In particular, a system, driver, and method are provided that solve the problem associated with variations in PVT. An intelligent feedback system is disclosed that enables the light source driver, which may also be referred to herein as an LED driver, to sense variations in at least one operating characteristic of the light source and adjust the amount of current provided to the light source. The variations may be sensed during the operation of a single driver (e.g., from use-to-use) or from one driver to another (e.g., to sense variations produced as a result of manufacturing variances). As such, the driver is capable of responding (e.g., in real-time or from driver-to-driver) to changes in the light source characteristics (e.g., PVT variations).

While embodiments of the present disclosure will primarily be described in connection with LED drivers, it should be appreciated that embodiments of the present disclosure are not so limited.

Various aspects of the present disclosure will be described herein with reference to drawings that are schematic illustrations of idealized configurations. It should be appreciated that while particular circuit configurations and circuit elements are described herein, embodiments of the present disclosure are not limited to the illustrative circuit configurations and/or circuit elements depicted and described herein. Specifically, it should be appreciated that circuit elements of a particular type or function may be replaced with one or multiple other circuit elements to achieve a similar function without departing from the scope of the present disclosure.

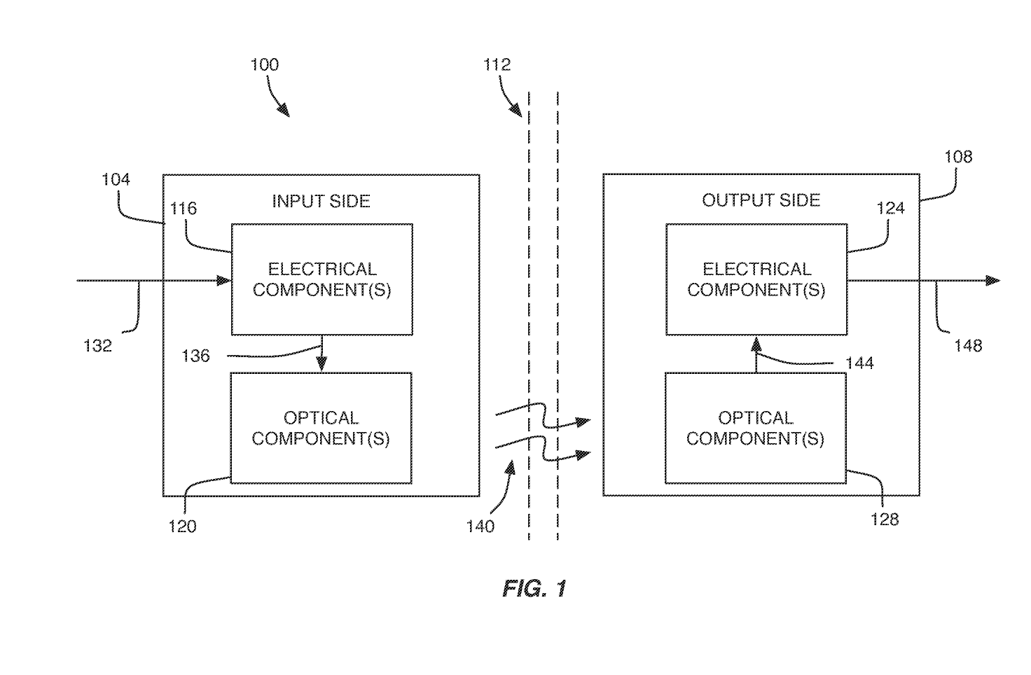

With reference now to FIG. 1, an illustrative optical communication system 100 will be described in accordance with at least some embodiments of the present disclosure. The communication system 100 is shown to include an input side 104 and output side 108 separated from one another by an isolation gap 112. In some embodiments, the isolation gap 112 may include one or more materials, dimension, or space that electrically isolate the input side 104 from the output side 108 (e.g., with insulative materials, sufficient distances to prohibit arcing, etc). Examples of a communication system 100 may include optical encoders, optocouplers, or any other electrical isolation product. In some embodiments, the components of the input side 104 and output side 108 may be provided on separate circuits or leadframes to further facilitate electrical isolation. The isolation gap 112 may include any type of material or combination of materials suitable for facilitating electrical, magnetic, and/or capacitive isolation. While embodiments of the present disclosure will primarily be discussed in connection with electrical isolation and an optical communication system utilizing the same, it should be appreciated that magnetic or capacitive isolators or barriers can be used.

At least some of the components of the input side 104 and/or output side 108 may be implemented using conventional CMOS design and manufacturing techniques and processes to provide, for example, a single integrated circuit or ASIC. It should be appreciated, however, that other manufacturing techniques and/or processes can be used to achieve non-integrated solutions.

As shown in FIG. 1, the input side 104 may include one or more electrical components 116 and one or more optical components 120. Likewise, the output side 108 may include one or more electrical components 124 and one or more optical components 128. In operation, the input side 104 may receive an input electrical signal 132 at its electrical component(s) 116. The electrical components may, in response to the input electrical signal 132, produce a driving signal 136 that is provided to the optical component(s) 120. The driving signal 136 may be provided as electrical current, which is subsequently converted into an optical signal 140 by the optical component(s) 120. The optical signal 140 may be transmitted across the isolation barrier 112 as emitted light or photons.

The optical signal 140 is then received at the optical component(s) 128 of the output side 108, where the emitted light or photons are converted back into an electrical current (e.g., an electrical signal) 144. The electrical signal 144 produced by the optical component(s) 128 of the output side 108 may then be provided to the electrical component(s) 124 of the output side 108, which produces an output signal 148 in response thereto. In some embodiments, the electrical component(s) 124 of the output side 108 may correspond to an amplifier or the like that is capable of boosting the electrical signal 144 into a stronger signal capable of operating with other circuitry.

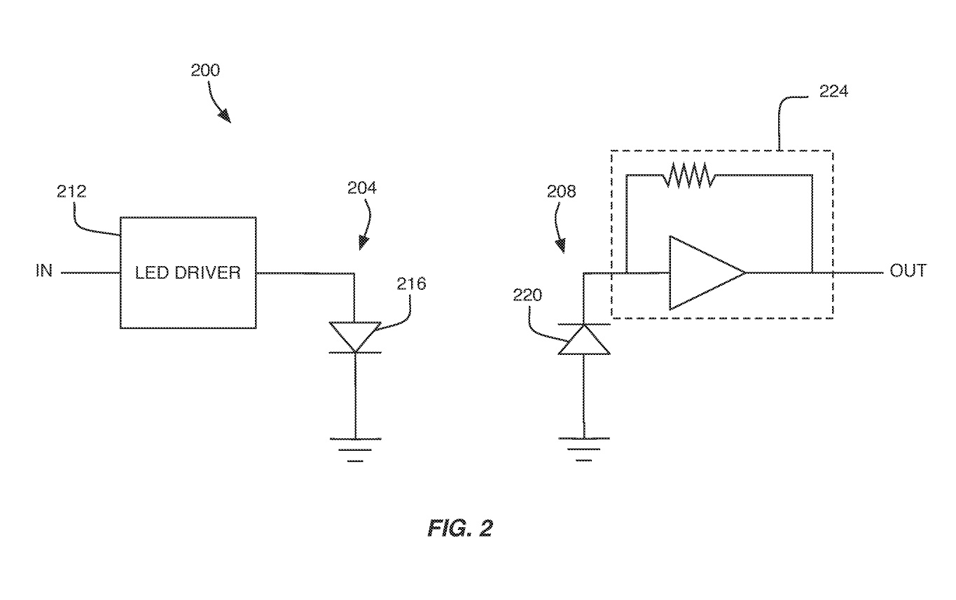

FIG. 2 depicts additional details of an illustrative optical communication system 200, which may be a specific version of the communication system 100 or identical to the communication system 100. The optical communication system 200 is shown to include an input side 204, which may be analogized to the input side 104, and an output side 208, which may be analogized to the output side 108.

The input side 204 is depicted as including an LED driver 212 and at least one LED 216. The LED 216 is connected between the LED driver 212 and ground and the LED driver 212 receives and input signal and drives the LED 216 according to the input signal.

The output side 208 is depicted as including a photodiode 220 and a Trans-Impedance Amplifier (TIA) 224. The specific configuration of the TIA 224 shown in FIG. 2 is but one possible configuration and should not be construed as limiting the embodiments of the present disclosure. The optical signal received at the photodiode 220 is converted into a first electrical signal, which is subsequently amplified or boosted by the TIA 224 into an output signal.

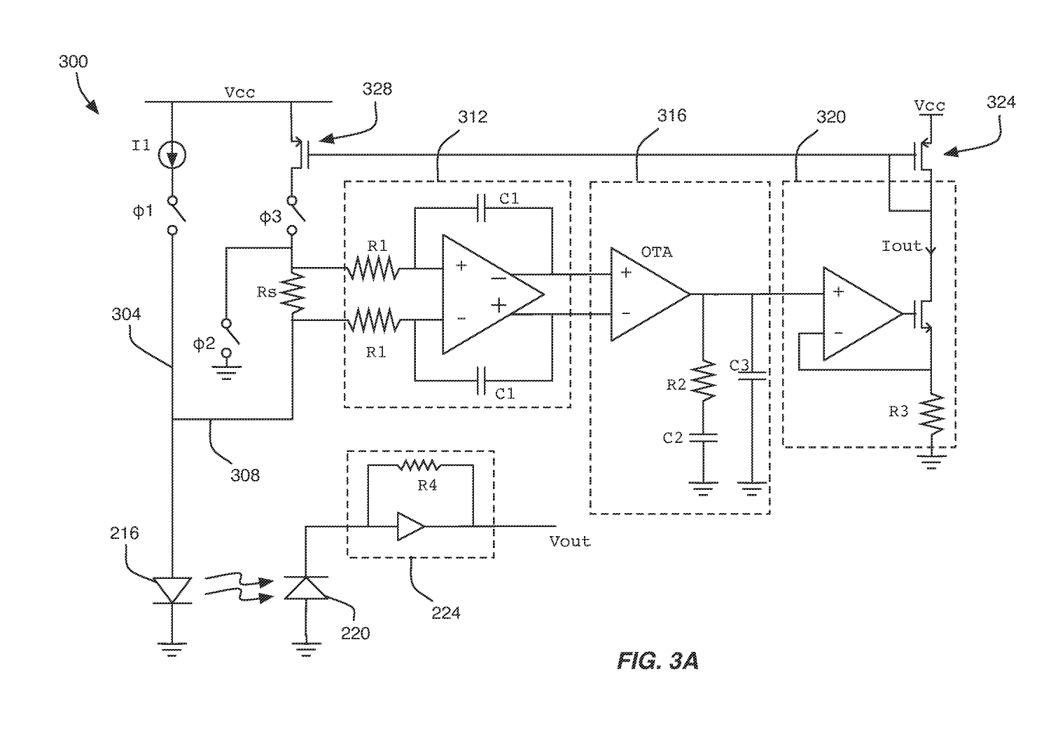

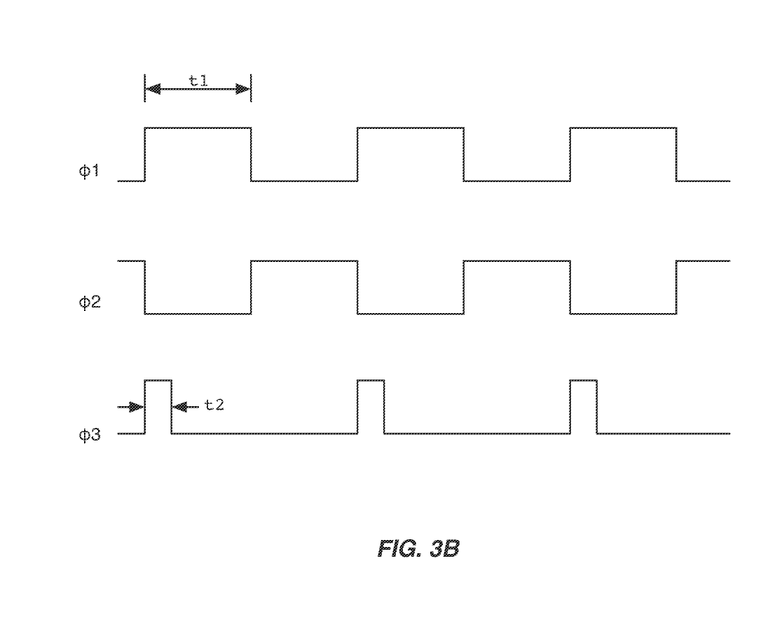

With reference now to FIGS. 3A-5B, additional details of an LED driver 212 will be described in accordance with embodiments of the present disclosure. A first possible LED driver 212 configuration is shown in FIG. 3A and a timing diagram associated therewith is shown in FIG. 3B. The LED driver circuitry 300 shown in FIG. 3A is depicted as including a first input branch 304 and a second input branch 308, each of which are used to provide input current to the LED 216. The first input branch 304 and second input branch 308 are shown as being connected in parallel to one another (e.g., in parallel between the input side, Vcc, and the LED 216). The first input branch 304 is shown to not include a feedback loop, whereas the second input branch 308 is shown to include a feedback loop.

The first input branch 304 is relatively simple and is shown to provide a first driving current I1 to the LED 216. The first driving current I1 may be provided by any time of current source (e.g., transistor, plurality of transistors, etc.) that is capable of generating and providing electrical current. The first driving current I1 is sufficient to primarily drive the LED 216 so as to enable the LED 216 to transmit the optical signal 140 across the isolation barrier 112. In some embodiments, the first driving current I1 is provided to the LED 216 when a first switch operated according to control signal Φ1 is closed. On the other hand, when the first switch operated accoring to control signal Φ1 is opened, the first driving current I1 is not provided to the LED 216. In other words, the LED 216 is activated or turned-on when at least the first driving current I1 is provided to the LED 216 through the closed first switch.

The second input branch 308 provides a dynamic feedback mechanism for the LED driver 212. Specifically, the second input branch 308 is configured to provide a second driving current or variable current to the LED 216 when a third switch operated according to control signal Φ3 is closed. The current provided via the second input branch 308 is substantially larger than the first driving current I1 because the current provided by the second input branch 308 is used to boost the LED 216 from 0 V to V_{D} as quickly as possible. This is referred to as current-pulse peaking As mentioned above, the first driving current I1 is used as the actual driving current to keep the LED 216 on for a longer amount of time, thereby enabling transmission of the optical signal 140 across the isolation barrier 112.

As can be seen in FIG. 3A, the second branch 308 includes two switches, namely a second switch operated according to control signal Φ2 and a third switch operated according to control signal Φ3. As mentioned above, the third switch operated according to control signal Φ3 controls whether or not current is provided from the second input branch 308 to the LED 216. As shown in FIG. 3B, the amount of time that the third switch is closed (e.g., time t2) is significantly less than the amount of time that the first switch is closed (e.g., time t1). Thus, the current provided by the second inupt branch 308 is only provided to the LED 216 to boost the turn-on of the LED 216. In some embodiments, the current provided by the second input branch 308 is significantly larger than the first driving current Il and can be as much as 5 to 10 times larger than the first driving current I1.

The second switch operated according to control signal Φ2 is also included in the second input branch 308 and is used to control the feedback circuit of the second input branch 308 to make sure the current provided thereby is not provided to the LED 216 when the first switch operated according to control signal Φ1 is open. Thus, as seen in FIG. 3B, the first and second switches are operated in opposite logic to one another and are approximatley 180 degrees out of phase with one another.

In accordance with at least some embodiments of the present disclosure, the second input branch 308 represents a feedback mechanism to automatically adjust the amount of current provided to the LED 216 (e.g., by increasing or decreasing the amount of the current provided to the LED 216). In some embodiments, the second input branch 308 is capable of detecting variations in the operating characteristics of the LED 216 (e.g., PVT variations) and can adjust the amount of charging-up energy provided to the LED 216 during turn-on. In some embodiments, the second input branch 308 is capable of detecting and accommodating for variations in LED 216 characteristics from one circuit to another. Said another way, the second input branch 308 may be used to optimize the behavior of the driver circuitry 300 to specifically accommodate the LED 216. Since manufacturing tolerances may result in different LEDs having slightly different operating characteristics from one LED to the next, if the driver circuitry 300 of multiple different drivers is provided with the second input branch 308 as disclosed, the LED 216 of each different driver circuitry 300 can be optimally driven due to the control feedback provided by the second input branch 308. The second input branch 308 is also configured to stablilize itself such that all of the light energy produced by the LED 216 is actually provided from the first driving current I1, independent of LED conditions. The LED turn-on time and turn-off time (e.g., response speed) will eventually tend to balance due to the feedback configured of the loop provided in the second input branch 308. This will create an output waveform at the TIA 224 that is substantially close to ideal (e.g., squared).

The feedback loop of the second input branch 308 is shown to include an integrator 312, a stabilizer 316, a voltage-to-current converter 320, and current mirror components 324, 328. In some embodiments, the integrator 312 corresponds to a differential integrator 312 that is connected across a sensing resistor Rs. The sensing resistor Rs is placed in the signal path between Vcc and the LED 216. The sensing resistor Rs is used to sense the peaking energy flowing into the LED 216 via the second input branch 308. The measurement of the peaking energy via the sensing resistor Rs can be used to control the amount of current provided to the LED 216 from the second input branch 308. It should be apprecaited that other circuit components can be used in addition to or in lieu of the sensing resistor Rs. Examples of suitable components include, without limitation, a sensing capacitor, a sensing transformer, a capacitor circuit, an inductor circuit, or any other component or combination of components suitable for sensing charge and/or current.

The integrator 312 is connected across the sensing resistor Rs such that the capacitors C1 in the integrator 312 are able to store charge information related to the sensing resistor when the second switch is opened. The current/charge information determined by the integrator 312 can be provided to the stabilizer 316, which may include an Operational Trans-conductance Amplifier (OTA) along with a subsequent filter array of R2, C2, and C3. The OTA and filter array of the stabilizer 316 are used to remove unwanted noises from the output of the integrator 312 and extend the loop bandwidth by adding one or more poles (as determined by the number of capacitors C2 and C3) and a zero to the signal. The depicted filter array will add two poles and one zero to the signal.

The output of the stabilizer 316 is provided to the voltage-to-current converter 320, which simply converts the voltage output from the OTA into current lout. The current produced by the voltage-to-current converter 320 is flowed through resistor R3 and is also feedback for the current to be provided from the second input branch 308 to the LED 216 by a current mirror 324, 328.

The loop configuration of the second input branch 308 will automatically adjust in response to variations of the LED's 216 behavior, either from cycle-to-cycle (e.g., to accommodate slight variations in LED behavior during operation) or from circuit-to-circuit (e.g., to accommodate slightly different LEDs). Specifically, as the LED's 216 operating characteristics change in response to PVT variations, the second input branch 308 will automatically adjust the current provided to the LED 216. This will help handle the LED 216 across a large capacitance variations and prevent glitches from occurring. Moreover, the second input branch 308 will help to optimize the power consumption of the driver circuit 300 according to the actual needs of the LED 216 (e.g., no excess wasted energy). Furthermore, the second input branch 308 can help each circuit individually accommodate slightly different LEDs 216. Further still, the second input branch 308 enables the driver circuitry 300 to speed up the charge-up time for the LED 216, thereby resulting in closer to ideal waveform outputs by the LED 216.

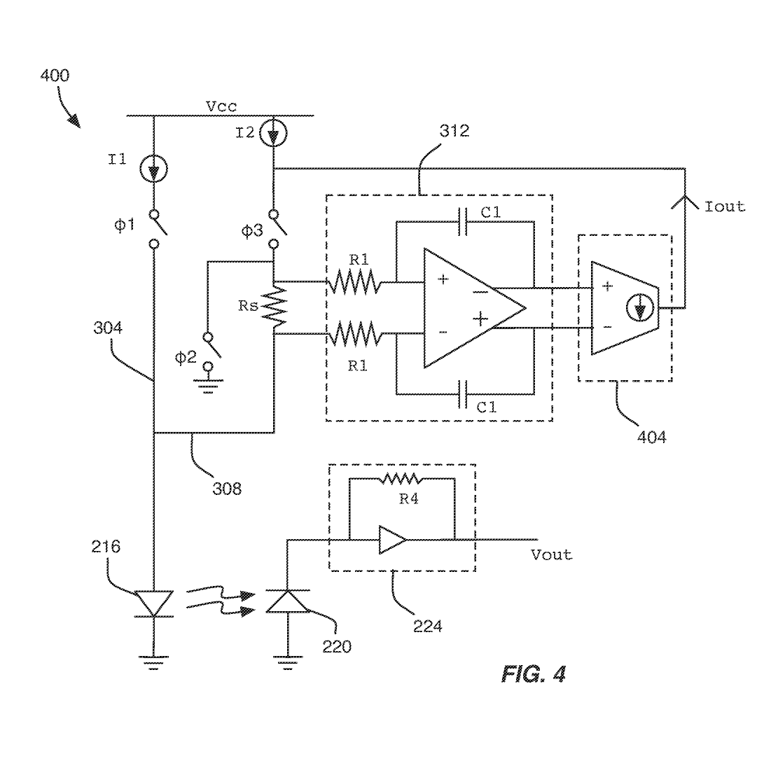

FIG. 4 depicts a second possible configuration of the driver circuit 400 in accordance with at least some embodiments of the present disclosure. As with the first configuration of the driver circuit 300, the second configuration of the driver circuit 400 is adapted to provide current-pulse peaking to the LED 216. Similar to the first configuration of the driver circuit 300, the driver circuit 400 comprises a first input branch 304 and second input branch 308. The functionality of the input branches 304, 308 are similar or identical to the functionality of the input branches 304, 308 in the driver circuit 300.

The difference in the second configuration of the driver circuit 400 is that a differential voltage-to-current converter 404 is used in place of the voltage-to-current converter 320. The differential voltage-to-current converter 404 is configured to directly receive an output from the differential integrator 312 and provide the lout and feedback to the second driving current 12. Because there is no OTA and filter array, the driver circuit 400 is somewhat simpler than the driver circuit 300. Without the filter array, however, the driver circuit 400 is not able to add any poles or zeros to the feedback signal. The operation of the switches in the driver circuit 400 may follow the timing diagram of FIG. 3B.

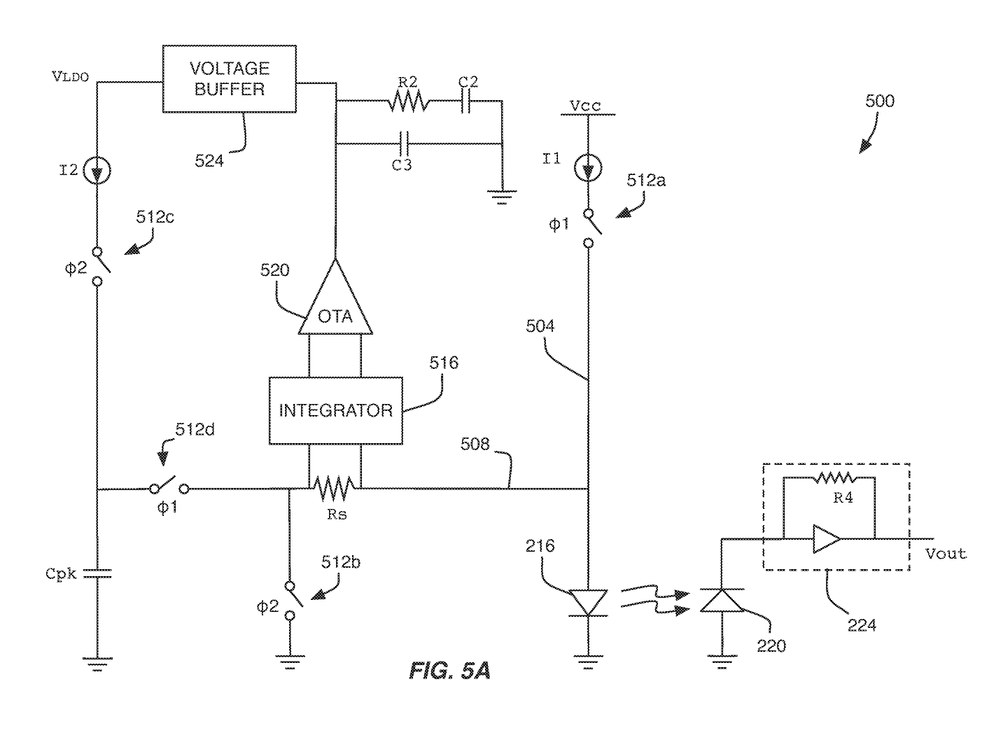

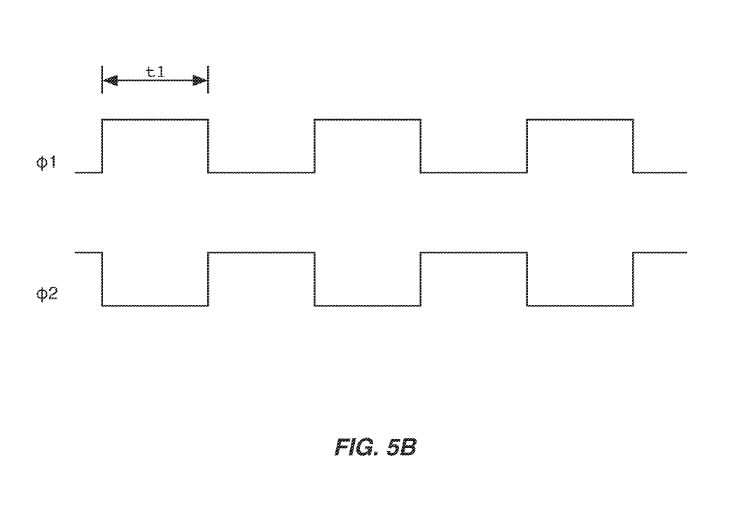

FIGS. 5A and 5B depict another possible configuration of an LED driver 212 in accordance with embodiments of the present disclosure. Specifically, a third driver circuit 500 is depicted in which capacitive-charge peaking is used instead of current-pulse peaking In other words, instead of feedback being provided via an output current lout, the feedback loop of the driver circuit 500 controls the capacitor voltage of a peaking capacitor Cpk. In this configuration, the capacitor Cpk stores the necessary charge to boost the LED 216 from 0 V to the turn-on voltage V_{D}. Similar to the previous circuits, however, the third driver circuit 500 comprises a first input branch 504 and second input branch 508. The first input branch 504 is similar or identical to the first input branches of the other driver circuits and the first input branch 504 provides the first driving current I1 to the LED 216. The first driving current I1 is controlled by operation of a first switch 512a operated according to control signal Φ1.

The second input branch 508, on the other hand, utilizes the capacitor Cpk to boost the LED 216. The second input branch 508 includes the sensing resistor Rs, whose function is similar or identical to the other sensing resistors Rs described herein. In some embodiments, the sensing resistor Rs is used to sense the current discharge from a second switch 512b that is operated according to control signal Φ2. The sensing resistor Rs is also configured to sense the charging current for capacitor Cpk through a fourth switch 512d operated according to control signal Φ1. The charging of the capacitor Cpk may be achieved by operation of a third switch 512c that is operated according to control signal Φ2. Similar to the other driver circuits 300, 400, the third driver circuit 500 may include an integrator 516, an OTA 520, and a filter array that includes R2, C2, and C3. The third driver circuit 500, however, does not need a voltage-to-current converter and, therefore, utilizes a voltage buffer 524 or the like.

The voltage buffer 524 may be configured to adjust the output voltage VLDO according to the output voltage of the OTA 520, which in-turn is used to provide current to charge the capacitor Cpk all the way to the output voltage of the voltage buffer 524. Therefore, the amount of charage provided to the capacitor Cpk is controlled by the second driving current I2, operation of the third switch 512c, and can be dynamically varied based on the operating characteristics of the LED 216 (e.g., due to the placement of the sensing resistor Rs). As with the other circuitry, the amount of charge provided from the capacitor Cpk to the LED 216 may accommodate for variances in the characteristics of the LED 216 inherently created due to manufacturing variances.

When the fourth switch 512d is closed, the other switches in the second input branch 508 will be opened, thereby enabling the capacitor Cpk to provide the boosing voltage to the LED 216. This boosting voltage will be provided in a relatively short amount of time (e.g., an amount of time less than time t1) as compared to the amount of time that the LED 216 is driven by the first input branch 504. As can be seen in FIG. 5B, the control signal Φ1 is approximately 180 degrees out of phase with control signal Φ2.

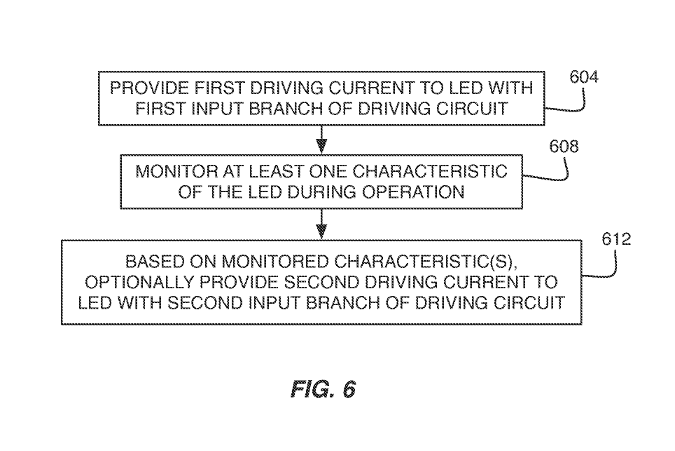

With reference now to FIG. 6, a method of driving an LED 216 with any one of the driver circuits discussed herein will be described in accordance with embodiments of the present disclosure. The method begins with an LED driver providing a first driving current Il to the LED 216 via a first input branch of the driving circuit (step 604). Thereafter or simultaneous therewith, at least one characteristic of the LED is monitored via a second input branch of the driver circuit (step 608). The amount of charging current and/or voltage needed by the LED 216 may be monitored by use of a sensing resistor Rs in the second input branch.

Based on the monitored characteristic and changes thereto as a result of PVT variations, or based on imperfections in the LED 116, the second input branch may optionally provide a boosting current (e.g., a second current) to the LED (step 612). In some embodiments, the second current may provided directly to the LED 216. In other embodiments, the second current may be provided indirectly to the LED 216 via a charging capacitor Cpk. As the operating characteristics of the LED 216 change from cycle-to-cycle, the second input branch may adjust the amount of the second current provided to the LED 216. In some embodiments, the variations in behavior of the LED will settle and the second input branch will become balanced and no second current will be provided to the LED 216.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A light source driver circuit, comprising:
a first input branch connected to an input of a light source, wherein the first input branch carries a first driving current to the input of the light source;
a second input branch also connected to the input of the light source, wherein the second input branch is connected in parallel with the first input branch, wherein the second input branch selectively carries a second current to the input of the light source, wherein the second input branch includes a feedback loop whereas the first input branch is independent of the feedback loop, and wherein the feedback loop enables the second input branch to accommodate variations in at least one characteristic of the light source.

2. The light source driver circuit of claim 1, wherein a first switch controls whether the first driving current is provided to the input of the light source, wherein a second switch controls discharge of current to the light source, and wherein the first and second switches are approximately 180 degrees out of phase from one another.

3. The light source driver circuit of claim 2, wherein a third switch is positioned in the second input branch to periodically pulse the second input starting at a time when the first switch begins providing the first driving current to the input of the light source and ending at a time before the first switch stops providing the first driving current to the input of the light source.

4. The light source driver circuit of claim 3, wherein the first driving current drives the light source for an amount of time sufficient for the light source to transmit an optical signal, wherein the second current is provided to the light source for an amount of time that is shorter than the amount of time which the first driving current is provided to the light source, and wherein the second current boosts the light source from zero Volts to a driving voltage (VD) with current-pulse peaking.

5. The light source driver circuit of claim 3, wherein the second input branch further comprises a sensing element that is positioned in the second input branch such that the second input branch is allowed to sense an amount of charging current flowing through the third switch and an amount of discharging current flowing through the second switch.

6. The light source driver circuit of claim 5, wherein the sensing element comprises at least one of a sensing resistor, a sensing transistor, a sensing capacitor, a capacitor circuit, and an inductor circuit.

7. The light source driver circuit of claim 5, wherein a differential integrator is connected to the sensing element, wherein the differential integrator is configured to store current information from the sensing element based on the amount of charging and discharging current flowing through the second input branch.

8. The light source driver circuit of claim 7, wherein the second input branch further comprises an operational transconductance amplifier and filter array that processes an output of the differential integrator by removing noise from the output of the differential integrator and extending loop bandwidth by adding at least one of a pole and zero to the output of the differential integrator.

9. The light source driver circuit of claim 8, wherein the second input branch further comprises a voltage-to-current converter that receives an output voltage from at least one of the differential amplifier and the operational transconductance amplifier and converts the received output voltage into a current that is provided as feedback to the sensing element.

10. The light source driver circuit of claim 1, wherein the second branch creates a feedback loop that, when stabilized, causes the amount of charging current flowing through the third switch to be the same as the amount of discharging current flowing through the second switch.

11. The light source driver circuit of claim 1, wherein the at least one characteristic of the light source comprises at least one of capacitance and turn-on voltage and wherein the at least one of capacitance and turn-on voltage of the light source vary across at least one of process, voltage, and temperature.

12. The light source driver circuit of claim 1, wherein the at least one characteristic of the light source comprises a variance in the light source created due to manufacturing imperfections.

13. The light source driver circuit of claim 1, wherein the second input branch comprises a capacitor that at least partially supplies the second current to the input of the light source.

14. An optical communication system, comprising:
a Light Emitting Diode (LED) configured to be driven by an LED driver circuit, wherein the LED driver circuit receives a communication system input and drives the LED according to the communication system input, wherein the LED driver circuit comprises:
a first input branch connected to an input of the LED, wherein the first input branch carries a first driving current to the input of the LED;
a second input branch also connected to the input of the LED, wherein the second input branch is connected in parallel with the first input branch, wherein the second input branch selectively provides a second current to the input of the LED, and wherein the second input branch accommodates variations in at least one characteristic of the LED; and
a light detector configured to detect the light produced by the LED and convert the detected light into an output current.

15. The optical communication system of claim 14, wherein the output current is provided to a trans-impedance amplifier that converts the output current into a communication system output.

16. The optical communication system of claim 14, wherein a first switch controls whether the first driving current is provided to the input of the LED, wherein a second switch controls discharge of current to the LED, and wherein the first and second switches are approximately 180 degrees out of phase from one another.

17. The optical communication system of claim 16, wherein a third switch is positioned in the second input branch to periodically pulse the second input starting at a time when the first switch begins providing the first driving current to the input of the LED and ending at a time before the first switch stops providing the first driving current to the input of the LED.

18. The optical communication system of claim 17, wherein the first driving current drives the LED for an amount of time sufficient for the LED to transmit an optical signal, wherein the second current is provided to the LED for an amount of time that is shorter than the amount of time which the first driving current is provided to the LED, and wherein the second current boosts the LED from zero Volts to a driving voltage (VD) with current-pulse peaking.

19. The optical communication system of claim 17, wherein the second input branch further comprises a sensing element that is positioned in the second input branch such that the second input branch is allowed to sense an amount of charging current flowing through the third switch and an amount of discharging current flowing through the second switch, wherein a differential integrator is connected to the sensing resistor, wherein the differential integrator is configured to store current information from the sensing resistor based on the amount of charging and discharging current flowing through the second input branch, and wherein the second input branch further comprises an operational transconductance amplifier and filter array that processes an output of the differential integrator by removing noise from the output of the differential integrator and extending loop bandwidth by adding at least one of a pole and zero to the output of the differential integrator.

20. A method of driving a Light Emitting Diode (LED), the method comprising:
providing a first driving current to the LED with a first input branch; and
selectively providing a second current to the LED with a second input branch, wherein the second input branch is connected in parallel with the first input branch, and wherein the second input branch includes a feedback loop that controls the second current provided to boost the LED during start-up.
